(19) United States
(12) Patent Application Publication
(10) Pub. No.: US 2013/0167875 A1
(43) Pub. Date: Jul. 4, 2013

(54) WASHING AND CLEANING SYSTEM FOR CONTAINER TREATMENT MACHINES

(71) Applicant: Ludwig Clusserath, Bad Kreuznach (DE)

(72) Inventor: Ludwig Clusserath, Bad Kreuznach (DE)

(73) Assignee: KHS GmbH, Dortmund (DE)

(21) Appl. No.: 13/822,035

(22) PCT Filed: Aug. 26, 2011
(86) PCT No.: PCT/EP2011/004296

§ 371 Date: Mar. 11, 2013

(30) Foreign Application Priority Data
Sep. 14, 2010 (DE) 10 2010 045 269.6

(51) Int. Cl. B08B 9/08

(52) U.S. Cl. CPC B08B 9/0826
USPC 134/23; 134/133

(57) ABSTRACT

A first container treatment device includes a container feeding unit, a container removing unit, a feed line for a product, and a cleaning device for cleaning exterior surfaces using a cleaning fluid. The cleaning device has a track that runs at least in an angle range around an axis of rotation thereof. The track has a portion shaped as a hollow body such that some of said cleaning fluid can be guided along a section in the track. A robot is arranged on this track.

The invention relates to a device for cleaning container treatment machines or container treatment devices according to the preamble of claim 1 and to a corresponding method according to claim 15.

Machines for treating containers, such as bottles, cans or barrels, in particular kegs, are known. In general, one machine serves for one treatment step. Particularly when rinsing, filling and capping containers, machine and container surfaces are soiled from outside by overflowing charge or splashes of charge. The surrounding room is also a source of soiling, so that dust, particles, etc. adhere to the moist machine and container surfaces.

In order to remove this soiling, nozzle systems are provided which flush away the soiling. U.S. Pat. No. 7,143,793 B2 discloses such a system, in which a stationary nozzle block is arranged in front of the rotating filling machine, said nozzle block having nozzles directed radially in the direction of the filler axis as well as a nozzle arm which protrudes between the filling valve and the container holder and the nozzles of which are directed vertically upwards.

EP 0 374 586 B1 discloses a cleaning unit for a linear filler, in which a cleaning carriage which is equipped with a plurality of nozzles can be displaced back and forth horizontally on a rail in the interior of the filler.

These devices, which are suitable in principle, have the disadvantage that a high volume of water and cleaning agent is required in order to ensure a sufficiently large flush of fluid that reaches all the surfaces to be cleaned.

The problem addressed by the invention is therefore that of providing a device and a method which minimise the consumption of water and cleaning agents.

This problem is solved by the treatment device having the features of claim 1. The solution in method terms is achieved by a method having the features of claim 15. Advantageous embodiments are given in the dependent claims.

The essence of the container treatment device lies in a track running around all or part of the circumference, and a drive and support rail on which a robot or robot arm can be displaced. Provided as the drive for the robot or robot arm is a linear drive which is ideally configured as a linear direct drive. Known examples of such electromagnetic linear direct drives that can be used are torque motors, tubular linear motors or polysolenoid linear motors. The track should be provided at least in an angle range of 120° or more around the treatment device in order to be able optimally to reach all the exterior surfaces of a container treatment device.

With this cleaning device, which consists essentially of the robot or robot arm and the drive and support rail as well as the supply lines, any position on a container treatment machine or device can be approached very quickly and can be flushed in an absolutely precise manner with a minimal consumption of water and cleaning agent. The robot or robot arm has at least two, ideally six, axes and is telescopically height-adjustable with at least one arm segment. Due to the high travelling speeds, this cleaning system is able to use even brief stoppages in operation to clean parts or individual components of the container treatment plant or device. In particular, using the cleaning device it is possible to perform small-area cleaning operations after replacing parts, which is in turn advantageous from an energy and cost point of view.

Of particular advantage is the electromagnetic drive, which is particularly fast and exhibits little noise or vibration and enables extremely high positioning accuracy.

Besides the motor and the magnetic track, a servo controller and a high-resolution linear scale including a reading head are necessary system components for the linear drive. With this, the positioning times can be considerably minimised in comparison to customary, wheel-driven rail systems.

The track may be configured as a rail or rail system. It is possible that the track comprises at least one support or load-bearing rail, wherein a drive rail which accommodates the magnets can be separate or can be integrated in the load-bearing or support rail. The track is preferably arranged above the container treatment device. It is advantageous if the track for the robot or robot arm is attached to the protective housing which encloses or adjoins the container treatment device. It is advantageous if provided in the track is at least one set of points for changing from a first section, which is assigned for example to a first container treatment device, to a second section, which is assigned for example to a second container treatment device.

In an improved version, the track itself is configured as a fluid-conveying element in that parts of the track, for example a rail along the route, are configured as a square hollow body. Ideally at least one valve coupling is provided in or on the hollow body, to which valve coupling the robot or robot arm can fluidically connect itself. The robot or robot arm thus becomes independent of a central fluid supply. If the connection of the robot or robot arm to the valve coupling takes place via a hose piece, the robot can continue to move in a smaller section of the track.

It is beneficial if the coupling or the valve coupling is configured as a fast-action coupling. It is advantageous if such fast-action couplings have a plug element and a socket element, wherein the plug element can be inserted into the socket element, wherein the fast-action coupling is technically medium-tight once the connection has been established. It is conceivable that the plug element, as the so-called “male piece”, is assigned to the hose piece leading to the robot, with the socket element, as the so-called “female piece”, being arranged on the respective tap for example for the respective medium. The plug element is therefore movable like the robot, with the socket element being arranged stationary on the respective tap. Of course, it may also be provided that the socket element is provided on the hose piece leading to the robot, with the plug element then being arranged on the respective tap. In order to establish and to release the fast-action coupling, i.e. of the plug element and of the socket element, it is preferably provided that this takes place automatically, so that there is no need for manual connection. The robot can thus fluidically connect itself to the tap, as already mentioned above. To this end, the two elements (plug element/socket element) have suitable devices. For example, a special tool could be provided, for example configured as a docking cylinder. It is conceivable if each medium line or each fast-action coupling is assigned a respective docking cylinder which is arranged on a holding device, for example opposite the connecting element (plug element/socket element) on the hose piece. The respective docking cylinder can be connected to a medium store or energy store of the robot, so that the necessary actuation effect can be applied by means of the stored medium or the stored energy. As the actuating medium, compressed air for example may be stored in the medium store. This is useful since the medium store can thus be refilled via the respective tap. However, electrical actuation is also conceivable, so that for example batteries or a chargeable energy store may be provided as the energy store. It is beneficial if each tap has a predefined and in each case identical sequence of respective medium ports, wherein each docking cylinder can act on the respective medium port for connection and release purposes. However, it is also conceivable to provide just one docking cylinder which acts on the respective medium ports. It is also possible to provide the fluid supply in a combination port in which the necessary supply fluids, but also for example compressed air and energy connections, are combined. The respectively different medium and energy supply can thus be ensured using just one single fast-action coupling. Of course, the medium lines upstream and downstream of the fast-action coupling in the flow direction of the respective medium, but also in the respective connecting elements (plug element/socket element), are separate from one another.

The fluid supply via a pipeline (hollow body) integrated in the track has the advantage that the robot or robot arm is reduced in weight, since neither a long supply hose nor a fluid reservoir has to be provided and moved.

In one embodiment, it is provided that the robot or robot arm can grip and agitate a combined spray and suction head in order to clean the track itself. To this end, it is advantageous if the track and in particular the magnets are immediately dried again once they have been wetted with a conducting fluid. Provided in this cleaning head are two sections which are separated from one another by a separating element, for example a sealing or wiping lip. In the first segment of the spray and suction head, the fluid is discharged for flushing purposes; in the other element, the adhering residual fluid is sucked off and conveyed away. Depending on the respective control signals, the robot or robot arm can automatically remove this combined spray and suction head as well as all the other spray and/or cleaning heads from one or more provision stations provided along the route. If this suction head or a comparable suction head is provided, it is advantageous if at least one section or portion of the track is configured as a hollow body which serves as a suction line and is connected to a central or local compressor.

Further advantageous embodiments of the invention are disclosed in the dependent claims and in the following description of the figures, in which:

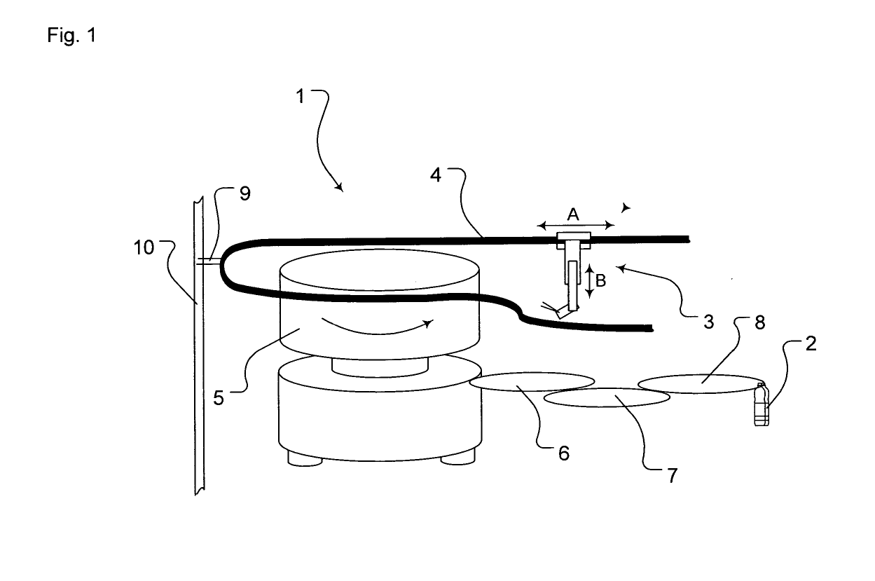

FIG. 1 shows a schematic view of a washing and cleaning system,

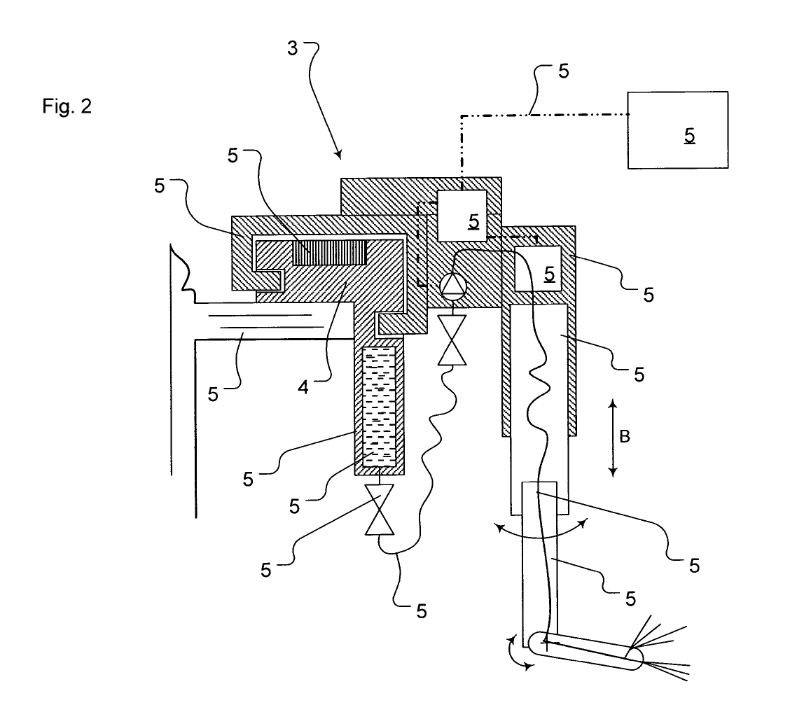

FIG. 2 shows the track and the robot or robot arm as an individual unit, and

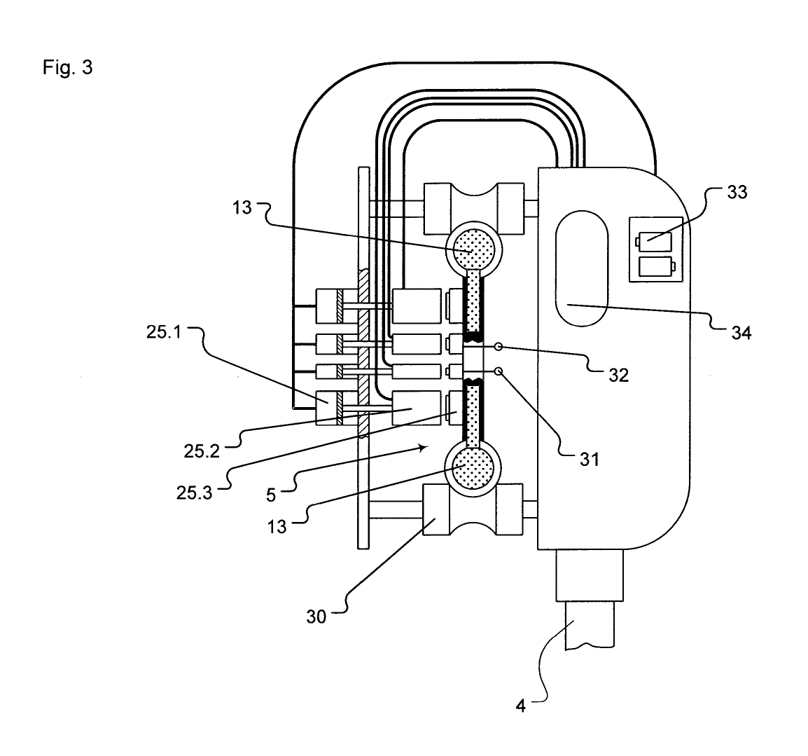

FIG. 3 shows the track and the robot for roller guidance.

In the different figures, identical parts are generally provided with the same reference signs and for this reason they are also described only once.

FIG. 1 shows a container treatment device 1, in particular a filler, capper or rinser, for containers, such as for example bottles, cans, barrels, kegs, etc. The containers are shown schematically in FIG. 1. The container treatment device 1 comprises a container feeding unit, a container removing unit, at least one feed line for at least one product, and a cleaning device 3 for cleaning the exterior surfaces by means of a cleaning fluid.

The cleaning device 3 comprises a robot 4 and a track 5, wherein the track 5 runs at least in an angle range around the axis of rotation thereof. The robot 4 is arranged on said track 5 and can be driven by means of a linear drive, and is displaceable along said track (double-headed arrow A).

It is also possible to see in FIG. 1 a supply device 7 (e.g. power, cleaning fluid, etc.) which is connected to the track 5.

It is therefore essential that the container treatment device 1 has a track 5 running around all or part of the circumference, and a drive and support rail 6 on which the robot 4 or a robot arm can be displaced. By way of example, the drive or support rail 6 forms the track 5. Provided as the drive for the robot 4 or robot arm is a linear drive 8 (FIG. 2) which is ideally configured as a linear direct drive.

The track 5 is preferably provided at least in an angle range of 120° or more around the treatment device in order to be able optimally to reach all the exterior surfaces of the container treatment device 1. In FIG. 1, the track 5 is arranged for example around approximately three-quarters of the circumference of the container treatment device 1.

Details of the drive or support rail with the robot 4 arranged displaceably thereon can be seen in FIG. 2.

For the sake of simplicity, the drive or support rail 6 will be referred to below as the drive rail 6. As seen in the illustrated cross-section, the drive rail 6 is effectively in the shape of an inverted L with an upright web 9 which is vertical in the plane of the drawing and a transverse web 10 which extends to the left in the plane of the drawing.

The drive rail 6 has guide grooves 11 and 12. The guide groove 11 is formed in the transverse web 10, with the guide groove 12 being arranged in the upright web 9 below, for example immediately below, the transverse web 10.

The linear drive 8, configured by way of example as an electromagnetic direct drive, is arranged in the transverse web 10, on the top side thereof.

The upright web 9 is configured partially as a hollow body, for example as a square hollow body, in which cleaning agent 13 is accommodated so that the support rail 6 is advantageously itself configured to convey fluid.

The upright web 9 has, on a lower base 14 as seen in the plane of the drawing, a valve coupling 15 which will be discussed in more detail below.

The robot 4 has a guide region 16 designed to correspond to the support rail 6, which guide region encompasses the support rail 6 and engages with guide webs 17 and 18 in the guide grooves 11 and 12. The guide web 17 engages in the guide groove 11, with the guide web 18 engaging in the guide groove 12. The robot 4 is thus mounted on the drive rail 6 so as to be displaceable along the latter. The guide region 16 is adjoined by a cleaning head 19 with a cleaning arm 20.

The cleaning arm 20 is telescopically height-adjustable, as illustrated by means of the double-headed arrow 21. In addition, further movement possibilities of various arm segments are illustrated by means of the double-headed arrows 22 and 23. A spray head 24 is arranged on the cleaning arm 20.

Arranged on the cleaning head 19 is a valve coupling 25 which is connected to the valve coupling 15 of the upright web 9 by means of a hose piece 26 or other suitable connecting means. Further fluid-conveying connecting elements 27 lead preferably from the valve coupling 25 through the cleaning head 19 and inside the cleaning arm 20 to the spray head 24.

A control element 28, configured for example as a non-return valve, is arranged above the valve coupling 25 as seen in the plane of the drawing.

A central fluid supply 29 is shown in dash-dotted line, although this can also be omitted due to the advantageous configuration of the drive rail 6 as a fluid-conveying drive rail 6. The hollow body is connected to the supply device 7 by suitable means, so that the fluid reservoir in the upright web 9 can be supplied with cleaning agent. By means of the upright web 9 configured at least partially as a hollow body, the robot 4 is effectively independent of a central fluid supply, so that the robot 4 is reduced in weight since the required cleaning agent is accommodated in the support rail 6 itself. By virtue of the hose piece 26, the robot 4 is displaceable relative to the support rail 6 in a section corresponding to the effective length of the hose piece 26. The hose piece 26 may also be elastic, that is to say stretchable, to a certain extent so that destruction of the hose piece 26 can be avoided if the robot 4 is displaced by a distance longer than the effective length of the hose piece 26.

The robot 4 or the cleaning arm 20 thereof can be embodied in such a way that it grips the hose piece 26 in a suitable manner and automatically attaches to the valve coupling 15 or separates from the latter. For instance the robot 4 may, upon reaching the maximum travel defined by the effective length of the hose piece 26, separate the connection to the valve coupling 15 and attach to a different valve coupling 15.

The robot 4 shown in FIG. 3 is displaceable on rails which are arranged vertically and on which said robot is guided by rollers 30 arranged in pairs. In the illustrated example, the cleaning fluid 13 consists of two different fluids which each flow and/or are stored in one of the two rails. The valve coupling 25 comprises on the robot side a plurality of valve cylinders 25.1 which can be pneumatically driven and which each carry one component of the male or female piece of the coupling 25.2. The respective mating pieces of the couplings 25.3 are arranged between the running rails on the station shown. Reference 31 denotes a central pneumatic supply line, and reference 32 denotes a central electric supply line. The robot 4 further comprises a pneumatic storage element 34 and an electric storage element 33, such as for example an accumulator or a battery, which if necessary can be regularly filled or charged via the aforementioned supply lines.

By means of the advantageously configured cleaning device 3, any point on the container treatment device 1 can be flushed with cleaning agent. Of course, the containers 2 can also be flushed by means of the cleaning device 3.

### LIST OF REFERENCES

1 container treatment device
2 container
3 cleaning device
4 robot/robot arm
5 track
6 drive rail or support rail
7 supply device
8 linear drive
9 upright web of 6
10 transverse web of 6
11 guide groove in 6 and 10
12 guide groove in 6 and 9
13 cleaning agent in 6 and 9
14 base
15 valve coupling on 9
16 guide region
17 guide web on 16
18 guide web on 16
19 cleaning head
20 cleaning arm
21 movement arrow
22 movement arrow
23 movement arrow
24 spray head
25 valve coupling
   25.1 valve cylinder
   25.2 coupling piece
   25.3 coupling piece, mating piece of the coupling
26 hose piece
27 connecting elements
28 control element
29 central fluid supply
30 roller
31 supply line (pneumatic)
32 supply line (electric)
33 battery, accumulator
34 storage element (pneumatic)

1-16. (canceled)

17. An apparatus comprising a first container treatment device, said first container treatment device comprising a container feeding unit, a container removing unit, at least one feed line for at least one product, and a cleaning device for cleaning exterior surfaces using a cleaning fluid, wherein said cleaning device comprises a track that runs at least in an angle range around an axis of rotation thereof, said track having at least one portion shaped as a hollow body such that at least some of said cleaning fluid can be guided along a section in said track, and a robot arranged on said track.

18. The apparatus of claim 17, further comprising at least two valve couplings on said at least one portion shaped as a hollow body for automatically providing a fluid connection between said robot and said hollow body.

19. The apparatus of claim 17, further comprising at least two fast action valve couplings on said at least one portion shaped as a hollow body for automatically providing a fluid connection between said robot and said hollow body

20. The apparatus of claim 17, further comprising a linear drive configured for driving said robot.

21. The apparatus of claim 17, further comprising a linear direct drive configured for driving said robot.

22. The apparatus of claim 21, wherein said linear direct drive comprises a torque motor.

23. The apparatus of claim 21, wherein said linear direct drive comprises a tubular linear motor.

24. The apparatus of claim 21, wherein said linear direct drive comprises a polysolenoid linear motor.

25. The apparatus of claim 17, wherein said track comprises one of a rail and a rail system.

26. The apparatus of claim 17, wherein said track comprises at least one load-bearing or support rail, and a drive rail that accommodates magnets, said drive rail being separate from said at least one load-bearing or support rail.

27. The apparatus of claim 17, wherein said track comprises at least one load-bearing or support rail, and a drive rail that accommodates magnets, said drive rail being integrated in said at least one load-bearing or support rail.

28. The apparatus of claim 17, wherein said track is arranged above said first container treatment device.

29. The apparatus of claim 17, wherein said at least one portion shaped as a hollow body is configured such that said cleaning fluid flows towards said robot.

30. The apparatus of claim 17, wherein said at least one portion shaped as a hollow body is configured as a suction line through which fluid flows away from said robot.

31. The apparatus of claim 17, further comprising a protective housing enclosing said first container treatment device, wherein said track is attached to said protective housing.

32. The apparatus of claim 17, further comprising a set of points in said track for changing from a first section, which is assigned to said first container treatment device, and a second section, which is assigned to a second container treatment device.

33. The apparatus of claim 17, wherein said robot is configured to be displaced to enable cleaning at least portions of said track.

34. The apparatus of claim 17, wherein said robot comprises a treatment head for cleaning and, immediately thereafter, drying said track.

35. A method for cleaning a container treatment device comprising a container feeding unit, a container removing unit, and at least one feed line for at least one product, said method comprising providing a cleaning device for cleaning exterior surfaces using a cleaning fluid, and displacing a robot along a track that runs at least in an angle range around an axis of rotation, wherein displacing said robot comprises operating a linear drive coupled to said robot.
